(19) United States
(12) Patent Application Publication
(10) Pub. No.: US 2018/0262153 A1
(43) Pub. Date: Sep. 13, 2018

(54) MOTOR CONTROL SYSTEM

(71) Applicant: Mitsubishi Electric Corporation, Chiyoda-ku (JP)

(72) Inventor: Akira TANABE, Tokyo (JP)

(73) Assignee: Mitsubishi Electric Corporation, Chiyoda-ku (JP)

(21) Appl. No.: 15/564,109

(22) PCT Filed: Jul. 28, 2016
(86) PCT No.: PCT/JP2016/072138

§ 371 Date: Oct. 3, 2017

(51) Int. Cl. H02P 29/40; B23Q 15/12

(52) U.S. Cl. CPC H02P 29/40; B23Q 15/12

(57) ABSTRACT

A motor control system includes a control processing unit to generate a torque command based on a command signal for controlling a motor that drives a mechanical load, a detection signal output from a detector provided in the motor, and a control gain, and to control the motor based on the torque command, a parameter setting unit to perform parameter setting for setting a limit value of the torque command and the control gain, and an inertia estimating unit to estimate inertia of the motor based on the detection signal and the torque command. The inertia estimating unit estimates the inertia in a state where self-excited vibration occurs in the motor due to the parameter setting.

### FIELD

The present invention relates to a motor control system that includes a motor control device that drives an industrial mechanical device such as a machine tool.

### BACKGROUND

A device that drives an industrial mechanical device generally includes: a motor connected to a movable body, which is an object to be driven, via a mechanical transmission mechanism to transmit power to the movable body; and a motor control device that drives the motor based on a command signal input from a controller to cause the motor to operate in a target operation pattern and a detection signal from a detector that detects a position or a velocity of the motor.

In the motor control device, it is demanded to accurately obtain inertia of a movable body to be driven. Advantages of obtaining inertia are as follows.

First, by obtaining inertia, it is possible to find a setting index of a position gain or a velocity gain that is a parameter for calculation of position control or velocity control in the motor driving device, for controlling a mechanical device with stability and high accuracy.

Further, by obtaining inertia, it is possible to determine how much margin a time constant of a command signal input from the controller to the motor control device has, with respect to the connected motor. Therefore, it is possible to cause the motor to operate with an optimum time constant.

Meanwhile, in a conventional motor control device, inertia J is estimated from a torque T generated during an operation of a motor and an acceleration “a” that can be calculated from velocity feedback measured by a detector, based on an Expression

J=T/a.

Here, the torque T is a product of a current I applied to the motor and a torque constant Kt, and can be calculated from the velocity feedback of the motor and a result of current detection.

However, there is a problem that it is not easy to estimate inertia by simple processing with high accuracy.

In order to solve the above problems, Patent Literature 1 proposes a motor control device that applies a sinusoidal signal to a torque command in the motor control device, observes the velocity feedback described above and a current applied to a motor, and performs inertia estimation.

### CITATION LIST

### Patent Literature

Japanese Patent Application Laid-open No. 2010-148178

### SUMMARY

### Technical Problem

However, the conventional technique disclosed in Patent Literature 1 described above has a problem that it is necessary to store an operation pattern for estimation, which is not used in a normal operation of a mechanical device, in a control device, and therefore additional work is required.

Also, in the conventional technique disclosed in Patent Literature 1, there is a problem that it is necessary to acquire a maximum value and a minimum value of a periodic signal, and therefore accuracy of estimation is lowered unless appropriate values are acquired. With regard to this point, Patent Literature 1 also discloses a solution that converts the periodic signal into a signal with absolute values and performs averaging. However, this solution makes the processing more complexed.

The present invention has been achieved in view of the above problems, and an object of the present invention is to provide a motor control system that can achieve stable inertia estimation with high accuracy in a simple manner.

### Solution to Problem

In order to solve the above problems and achieve the object, the present invention includes: a control processing unit to generate a torque command based on a command signal for controlling a motor that drives a mechanical load, a detection signal output from a detector provided in the motor, and a control gain, and to control the motor based on the torque command, a parameter setting unit to perform parameter setting for setting a limit value of the torque command and the control gain; and an inertia estimating unit to estimate inertia of the motor based on the detection signal and the torque command. The inertia estimating unit estimates the inertia in a state where self-excited vibration occurs in the motor due to the parameter setting.

### Advantageous Effects of Invention

According to the motor control system of the present invention, an effect where stable inertia estimation can be achieved with high accuracy in a simple manner.

### BRIEF DESCRIPTION OF DRAWINGS

FIG. 1 is a block diagram illustrating a configuration of a motor control system according to a first embodiment of the present invention.

FIG. 2 is a block diagram of a modeled motor control process performed by a motor control device according to the first embodiment.

FIG. 3 illustrates a hardware configuration in a case where functions of a controller or the motor control device according to the first embodiment are achieved by a computer.

FIG. 4 is a flowchart illustrating processing at a time of inertia estimation according to the first embodiment.

FIG. 5 is a waveform chart illustrating a velocity of a motor and a torque command when self-excited vibration occurs in the first embodiment.

### DESCRIPTION OF EMBODIMENTS

A motor control system according to the embodiment of the present invention will be described in detail below with reference to the accompanying drawings. The present invention is not limited to the embodiment.

### First Embodiment

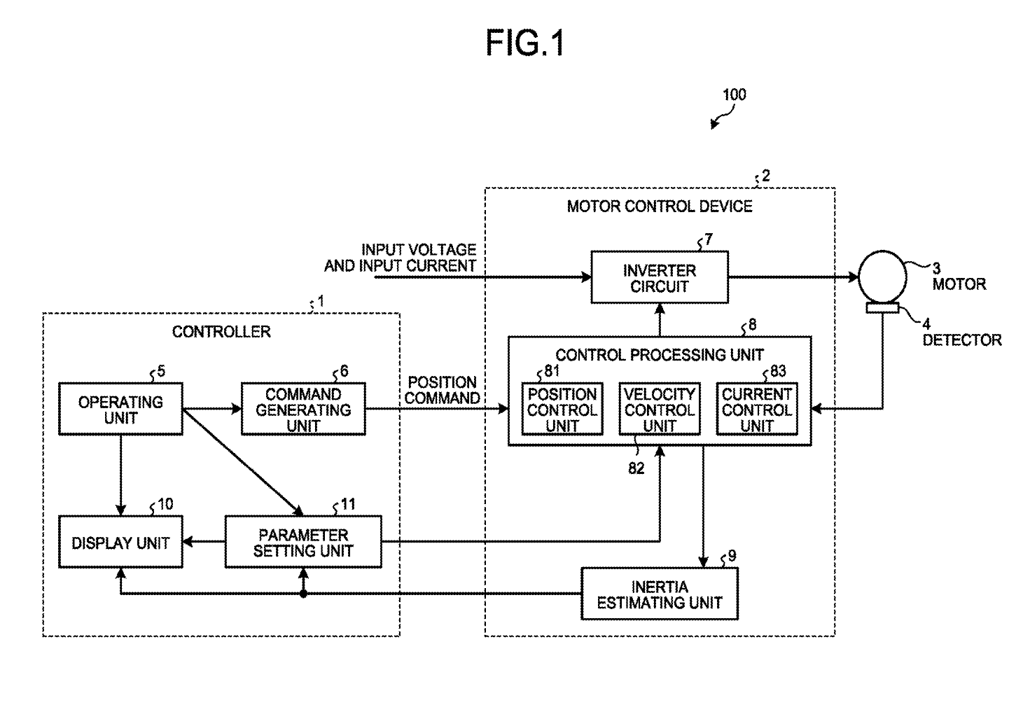

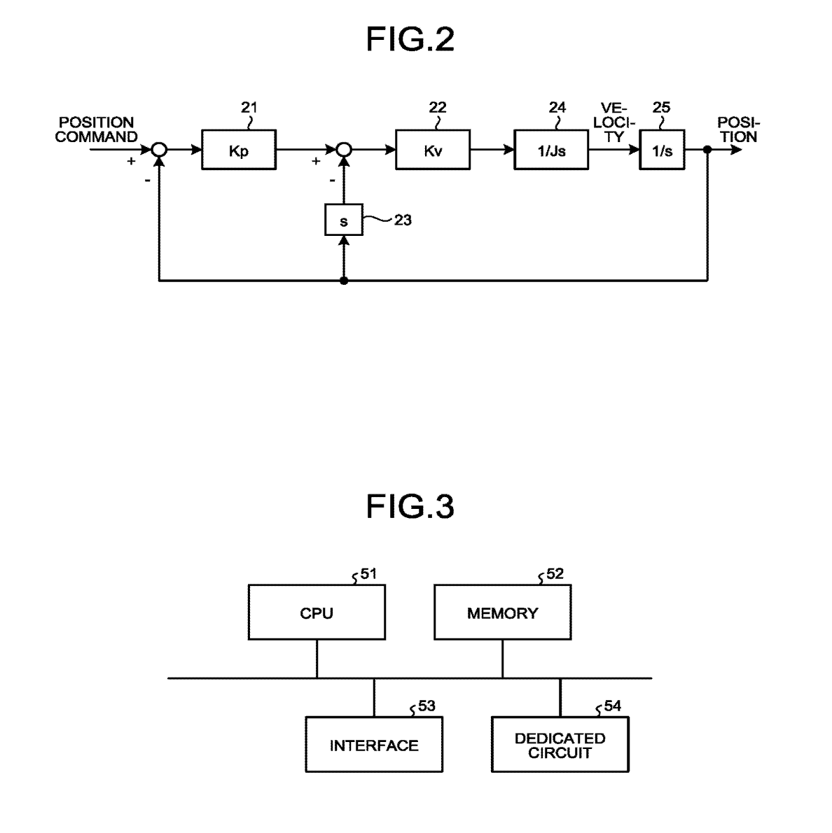

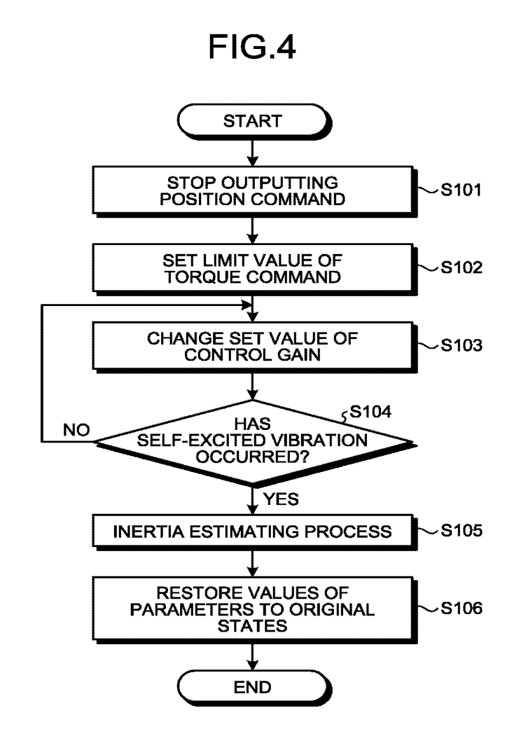

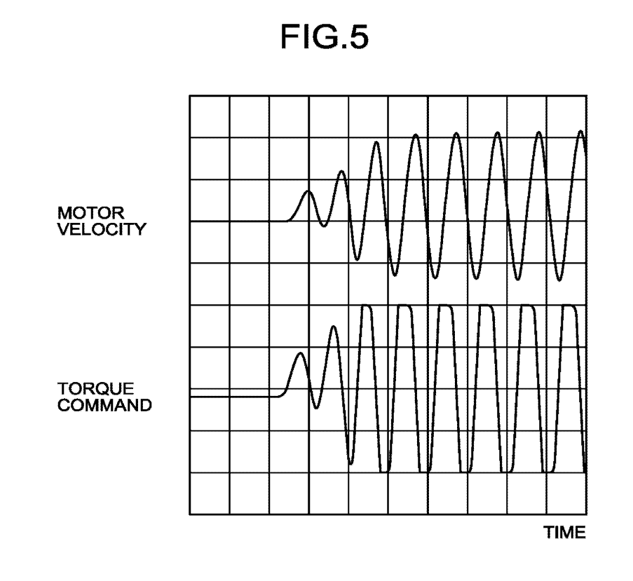

A motor control system 100 according to a first embodiment of the present invention is described below with reference to FIGS. 1 to 5. FIG. 1 is a block diagram illustrating a configuration of the motor control system 100 according to the first embodiment of the present invention. FIG. 2 is a block diagram of a modeled motor control process performed by a motor control device according to the first embodiment. FIG. 3 illustrates a hardware configuration in a case where functions of a controller 1 or the motor control device 2 according to the first embodiment are achieved by a computer. FIG. 4 is a flowchart illustrating processing at a time of inertia estimation according to the first embodiment. FIG. 5 is a waveform chart illustrating a velocity of a motor and a torque command when self-excited vibration occurs in the first embodiment.

In FIG. 1, the motor control system 100 includes the controller 1 that generates a position command, the motor control device 2 that is a servo amplifier supplying appropriate electric power to a motor 3 for driving an unillustrated mechanical load, the motor 3 that converts the supplied electric power to rotational power for a motor shaft, and a detector 4 provided in the motor 3. The position command is a command signal for controlling the motor 3. The controller 1 transmits a generated position command to the motor control device 2. A specific example of the detector 4 is an encoder. A detection signal output from the detector 4 is transmitted to the motor control device 2.

The controller 1 receives an operation by an operator, and generates a position command to be transmitted to the motor control device 2, based on received content, more specifically, a program command described in a program input by the operator. The detector 4 detects a rotational angle of the motor 3 and outputs a detection value as a detection signal. The motor control device 2 supplies appropriate electric power to the motor 3 based on the position command generated by the controller 1 and the detection signal of the detector 4.

The controller 1 includes an operating unit 5 that receives an operation by an operator, a command generating unit 6 that generates a position command to be transmitted to the motor control device 2, a parameter setting unit 11 that performs setting for parameters used in a control processing unit 8 of the motor control device 2 described later, and a display unit 10 that notifies the operator of information. The parameters used in the control processing unit 8 include a limit value of the torque command and a control gain to be described later. To set values of the parameters are referred to as “parameter setting”. Therefore, the parameter setting unit 11 performs parameter setting.

The motor control device 2 includes an inverter circuit 7 that supplies electric power to the motor 3, the control processing unit 8 that transmits an electric-power command to the inverter circuit 7 based on the position command received from the controller 1, and an inertia estimating unit 9 that performs a process for estimating inertia of the motor 3. The control processing unit 8 includes a position control unit 81 that performs position control calculation based on the position command and outputs a velocity command, a velocity control unit 82 that performs velocity control calculation based on the velocity command and outputs a torque command, and a current control unit 83 that performs current control calculation for outputting an electric-power command based on the torque command.

During a normal operation, the command generating unit 6 generates a position command for causing the motor 3 to perform a desired operation, based on an operation condition input by an operator to the operating unit 5, and transmits the generated position command to the control processing unit 8. The control processing unit 8 performs feedback control calculation based on the received position command and information about a rotational angle of the motor 3 received from the detector 4, and generates an electric-power command. The feedback control calculation includes position control calculation by the position control unit 81, velocity control calculation by the velocity control unit 82, and current control calculation by the current control unit 83. The inverter circuit 7 performs frequency conversion for an input voltage and an input current based on the electric-power command supplied thereto from the control processing unit 8, to supply appropriate electric power to the motor 3. In this manner, an operation required by the operator is achieved.

Here, set values of the parameters, for example, a set value of each control gain for calculation in the control processing unit 8 required in a normal operation, and a torque limit value for preventing a current equal to or larger than a maximum allowable current of the motor from being applied, are transmitted from the parameter setting unit 11 to the control processing unit 8 in an initial communication sequence performed when the controller 1 and the motor control device 2 are turned on. The state of parameter setting by the parameter setting unit 11 and the content of an operation state of the motor 3 are notified to an operator via the display unit 10.

FIG. 2 illustrates a motor control process by the motor control device 2 that is modeled into a block diagram of feedback control by comparison control, in which processing by the control processing unit 8, the motor 3, and the detector 4 in FIG. 1 are modeled. Here, “s” represents a Laplace operator. A position gain Kp and a velocity gain kv are control gains used in the control processing unit 8.

A position gain block 21 corresponds to processing in the position control unit 81, and a velocity gain block 22 corresponds to processing in the velocity control unit 82. Functions of the position gain block 21, the velocity gain block 22, and a differentiator 23 are included in functions of the control processing unit 8. A load 24 and an integrator 25 are models of processing in the motor 3 and the detector 4. A position of the motor 3 output from the integrator 25 corresponds to a detection signal output from the detector 4, that is, a rotational angle of the motor 3.

The position gain block 21 multiplies a difference between a position command and a position of the motor 3 output from the integrator 25 by the position gain Kp to obtain a velocity command, and outputs the velocity command. The differentiates 23 differentiates the position of the motor 3 output from the integrator 25 to obtain a velocity of the motor 3, and outputs the velocity of the motor 3. The velocity gain block 22 multiplies a difference between the velocity command supplied from the position gain block 21 and the velocity of the motor 3 supplied from the differentiator 23 by the velocity gain Kv to obtain a torque command, and outputs the torque command. In FIG. 2, blocks respectively corresponding to the current control unit 83 and the inverter circuit 7 in FIG. 1 are omitted. Therefore, the torque command output from the velocity gain block 22 is converted to a torque current corresponding to the torque command, and then output to the load 24. The load 24 converts the torque current to a velocity of the motor 3 by using inertia J. The integrator 25 integrates the velocity output from the load 24 to obtain the position of the motor 3, and outputs the position of the motor 3.

Transmission characteristics of a control system illustrated in FIG. 2 are represented by the following Formula (1).

$$\begin{matrix}[ Formula 1 ] & \\ G ( s ) = \frac{Kp \cdot Kv}{{s}^{2} + \frac{Kv}{J} s + \frac{Kp \cdot Kv}{J}} & ( 1 )\end{matrix}$$

Vibrational excitation by changing gain setting is described. In the control system illustrated in FIG. 2, when a value of the velocity gain Kv is decreased or a value of the position gain Kp is increased, destabilization caused by phase delay occurs, so that self-excited vibration of the motor 3 caused by feedback occurs. Even if there is no position command, self-excited vibration is caused to occur by changing the control gain in the above manner. Because of the self-excited vibration, the torque command also vibrates at the same frequency f. The frequency f of the self-excited vibration is represented by the following Formula

$$\begin{matrix}[ Formula 2 ] & \\ f = \frac{1}{2 π} \sqrt{\frac{Kp \cdot Kv}{J}} & ( 2 )\end{matrix}$$

In a case of achieving functions of the controller 1 or the motor control device 2 by a computer, the functions of the controller 1 or the motor control device 2 are achieved by a CPU (Central Processing Unit) 51, a memory 52, an interface 53, and a dedicated circuit 54 as illustrated in FIG. 3. A part of the functions of the controller 1 or the motor control device 2 is achieved by software or firmware, or a combination of the software and the firmware. The software or the firmware is described as a program and is stored in the memory 52. The CPU 51 reads out the program stored in the memory 52 and executes the program, thereby achieving the function of each unit. That is, the controller 1 or the motor control device 2 includes the memory 52 for storing therein programs that cause steps for performing an operation of the controller 1 or the motor control device 2 to be performed as a result when the functions of the respective units are performed by the computer. These programs may also be regarded as causing the computer to perform a procedure or a method of the controller 1 or the motor control device 2. The memory 52 corresponds to a nonvolatile or volatile semiconductor memory such as a RAM (Random Access Memory), a ROM (Read Only Memory), a flash memory, an EPROM (Erasable Programmable Read Only Memory), or an EEPROM (Electrically Erasable Programmable Read Only Memory), a magnetic disk, a flexible disk, an optical disk, a compact disk, a mini disk or a DVD (Digital Versatile Disk).

The CPU 51 of the controller 1 reads out the programs stored in the memory 52 and executes the programs, thereby achieving functions of the command generating unit 6 and the parameter setting unit 11. The interface 53 of the controller 1 has a function for transmitting a signal to and receiving a signal from the motor control device 2. A specific example of the dedicated circuit 54 of the controller 1 is a processing circuit, such as the operating unit 5 and the display unit 10.

The CPU 51 of the motor control device 2 reads out the programs stored in the memory 52 and executes the programs, thereby achieving functions of the control processing unit 8 and the inertia estimating unit 9. The interface 53 of the motor control device 2 has a function for transmitting a signal to and receiving a signal from the controller 1. A specific example of the dedicated circuit 54 of the motor control device 2 is the inverter circuit 7.

In this manner, the controller 1 or the motor control device 2 can realize the respective functions described above with hardware, software, firmware, or a combination thereof.

A specific processing method of inertia estimation in the first embodiment is described below with reference to FIG. 4.

First, the command generating unit 6 stops outputting a normal position command to the motor control device 2 (Step 101). Subsequently, the parameter setting unit 11 sets a limit value of a torque command for limiting the torque command to be generated by the motor 3 during inertia estimation in a state where self-excited vibration occurs, in the velocity control unit 82 (Step S102). The parameter setting unit 11 further changes a set value of a control gain in the control processing unit 8 (Step S103). Specifically, at Step S103, the parameter setting unit 11 decreases a value of the velocity gain Kv used by the velocity control unit 82 or increases a value of the position gain Kp used by the position control unit 81, thereby changing the set value of the control gain.

After the control gain is changed at Step S103, the inertia estimating unit 9 determines whether self-excited vibration has occurred in the motor 3 due to parameter setting by the parameter setting unit 11 (Step S104). Specifically, the inertia estimating unit 9 determines whether self-excited vibration has occurred, based on data acquired from the control processing unit 8. In a case where self-excited vibration has not occurred (NO at Step 104), the parameter setting unit 11 repeats the process at Step S103. Therefore, the parameter setting unit 11 changes the set value of the control gain in a stepwise manner until self-excited vibration occurs. As a result, the set value of the control gain is decreased or increased in a stepwise manner until self-excited vibration occurs.

In a case where self-excited vibration occurs (YES at Step S104), the inertia estimating unit 9 performs an inertia estimating process (Step S105). That is, the inertia estimating unit 9 estimates inertia of the motor 3 in a state while the self-excited vibration occurs in the motor 3. In a case where a limit value has been set for the torque command in a state where self-excited vibration at a frequency f represented by Formula occurs, vibration of the torque command in a rectangular waveform as illustrated in FIG. 5 occurs. In a case where vibration of the torque command occurs, a torque current input to the motor 3 also vibrates with the same waveform as that of the torque command. When an absolute value of the torque command is the limit value of the torque command that is a constant value, a velocity of the motor 3 accelerates or decelerates with a constant slope. Therefore, when vibration of the torque command occurs, the velocity of the motor 3 repeats acceleration and deceleration with a constant lope. In a state where waveforms of the velocity of the motor 3 and the torque command become steady waveforms in FIG. 5, the inertia estimating unit 9 performs inertia estimation.

Specifically, the inertia estimating unit obtains an acceleration of the motor 3 based on the velocity of the motor 3 output from the differentiator More specifically, the inertia estimating unit 9 obtains an acceleration when the velocity of the motor 3 accelerates or decelerates with a constant slope as described above. The inertia estimating unit 9 then estimates inertia J of the motor 3 by calculation that divides a value of the torque command output from the velocity control unit 82 by the acceleration of the motor 3 obtained in the above manner. That is, the inertia estimating unit 9 can estimate the inertia J simply by calculation that uses the velocity of the motor 3 obtained from the control processing unit 8 and the torque command. As described above, it is preferable suitable to perform calculation for estimating inertia by the inertia estimating unit 9, in a state where an absolute value of the torque command in a rectangular waveform as illustrated in FIG. 5 is set as a limit value of the torque command and an acceleration of the motor 3 is a constant value.

In a case where inertia estimation is performed in a state where a mechanical load is connected to the motor 3 at Step S105, inertia of the motor 3 including a mechanical system is obtained. In a case where inertia estimation is performed in a state where a mechanical load is not connected to the motor 3, inertia of the motor 3 alone is obtained.

After the inertia estimating process (Step S105), the parameter setting unit 11 restores the values of the parameters used in the control processing unit 8 set at Steps S102 and S103 to original states that allow a normal operation to be performed (Step S106). With the above process, an operation of inertia estimation can be completed.

As described above, in the motor control system 100 according to the first embodiment, it is possible to achieve inertia estimation only by simple processing that changes setting of parameters used in the control processing unit 8 of the motor control device 2. That is, the motor control system 100 can achieve inertia estimation by simple processing, only by performing a process of changing a control gain and a process of controlling a torque command by using a mechanism generally provided in a motor control system. Therefore, the motor control system 100 can achieve inertia estimation without implementing special processing or a special signal pattern for inertia estimation within the motor control device 2.

Further, in the motor control system 100 according to the first embodiment, inertia estimation is performed in a state where the torque command and an acceleration of the motor 3 take constant values and a calculation process can be stably performed, while self-excited vibration of the motor 3 occurs. That is, it is possible to estimate inertia by using a steady signal. Therefore, stable inertia estimation with high accuracy can be achieved.

In addition, a change of inertia of a mechanical device including the motor 3 falls within a certain range in accordance with the specification of a machine. Therefore, by adjusting the set value of the control gain, it is possible to adjust a range of a frequency value of the vibration in advance based on Formula (2). Accordingly, by controlling both the limit value of the torque command and the frequency simultaneously, the motor control system 100 can also adjust a vibration width that is a value obtained by integrating the velocity of the motor 3 during inertia estimation by a vibration period. Consequently, the motor control system 100 can also adjust vibration for inertia estimation flexibly in accordance with a condition, for example, a place of installation in a movable body of a mechanical device, or a stroke length of the movable body.

The configurations described in the above embodiment are only examples of the content of the present invention. The configurations can be combined with other well-known techniques, and a part each configuration can be omitted or modified without departing from the scope of the present invention.

### REFERENCE SIGNS LIST

1 controller, 2 motor control device, 3 motor, 4 detector, 5 operating unit, 6 command generating unit, inverter circuit, 8 control processing unit, 9 inertia estimating unit, 10 display unit, 11 parameter setting unit, 21 position gain block, velocity gain block, 23 differentiator, 24 load, 25 integrator, 51 CPU, 52 memory, 53 interface, 54 dedicated circuit, 81 position control unit, 82 velocity control unit, 83 current control unit, 100 motor control system.

1. A motor control system comprising:
a control processing unit to generate a torque command based on a command signal for controlling a motor that drives a mechanical load, a detection signal output from a detector provided in the motor, and a control gain, and to control the motor based on the torque command;
a parameter setting unit to perform parameter setting for setting a limit value of the torque command and the control gain; and
an inertia estimating unit to estimate inertia of the motor based on the detection signal and the torque command, wherein
the inertia estimating unit estimates the inertia in a state where self-excited vibration occurs in the motor due to the parameter setting.

2. The motor control system according to claim 1, wherein the inertia estimating unit estimates the inertia in a state where the torque command is in a rectangular waveform.

3. The motor control system according to claim 1, wherein the inertia estimating unit estimates the inertia in a state where an absolute value of the torque command is set as the limit value.

4. The motor control system according to claim 1, wherein the inertia estimating unit estimates the inertia based on an acceleration of the motor obtained from the detection signal, and the torque command.

5. The motor control system according to claim 1, wherein the control gain is a position gain or a velocity gain.

6. The motor control system according to claim 1, wherein the parameter setting unit changes the control gain in a stepwise manner until the self-excited vibration occurs.
